(19) United States
(12) Patent Application Publication
(10) Pub. No.: US 2018/0124385 A1
(43) Pub. Date: May 3, 2018

(54) VISUAL COMMUNICATION AND INFORMATION DISPLAY DEVICE WITH MULTIPLE VIEW POINT RENDERING

(71) Applicant: Sharp Laboratories of America, Inc., Camas, WA (US)

(72) Inventor: Petrus J. L. VAN BEEK, Vancouver, WA (US)

(21) Appl. No.: 15/337,606

(22) Filed: Oct. 28, 2016

(51) Int. Cl. H04N 13/04; H04N 9/12; H04N 5/64

(52) U.S. Cl. CPC H04N 13/0445; H04N 5/642; H04N 9/12

(57) ABSTRACT

A display device with a display.

### CROSS-REFERENCE TO RELATED APPLICATIONS

Not applicable.

### BACKGROUND OF THE INVENTION

The present invention generally relates to a multi-view display device.

With the advent of portable computing devices, such as tablets and smart phones, there is typically an integrated display that may be used to view content. The display is an integral component of these devices, although still an intermediary component towards consumption of and interaction with the visual content or communication with other people. The content may include many different types of content, such as textual material, graphical material, image and video content, and audio-visual communication. Flat panel displays using LCD and OLED technology are commonly used in portable computing devices. When the viewer observes content on such a portable computing device, they typically place the display of the device in direct alignment with their eyes in a perpendicular orientation so that they have a best view of the display and the content being rendered thereon.

When two or more viewers want to simultaneously view the content being displayed on the display, it tends to be awkward with either or both of the viewers being at an offset angular position with respect to the display. Moreover, typically one of the viewers is in control of the display, so to select, modify or interact with the content being displayed thereon by another viewer the portable computing device is typically handed to the other viewer so that the content may be selected, modified, or interacted with. While multiple viewers may simultaneously view the content being rendered on the display, the viewers tend to have limited interaction with one another, resulting in a limited shared experience and limited collaboration. Furthermore, with both of the viewers attention directed at the display, their eye contact with one another tends to be rather limited. Hence, although flat-panel displays on common consumer devices support personal and mobile content consumption very well, existing implementations have limitations especially for shared content consumption and communication use.

### BRIEF DESCRIPTION OF THE DRAWINGS

FIG. 1 illustrates a display device.

FIGS. 2A-2D illustrate different embodiments of the display device.

FIG. 3 illustrates a display device with microphones.

FIG. 4 illustrates a display device.

FIG. 5 illustrates content sharing with a display device.

FIGS. 6A-6D illustrate two viewers and a display device.

FIG. 7 illustrates a moving viewer and a display device.

FIG. 8 illustrates multiple viewers and a display device.

### DETAILED DESCRIPTION OF PREFERRED EMBODIMENTS

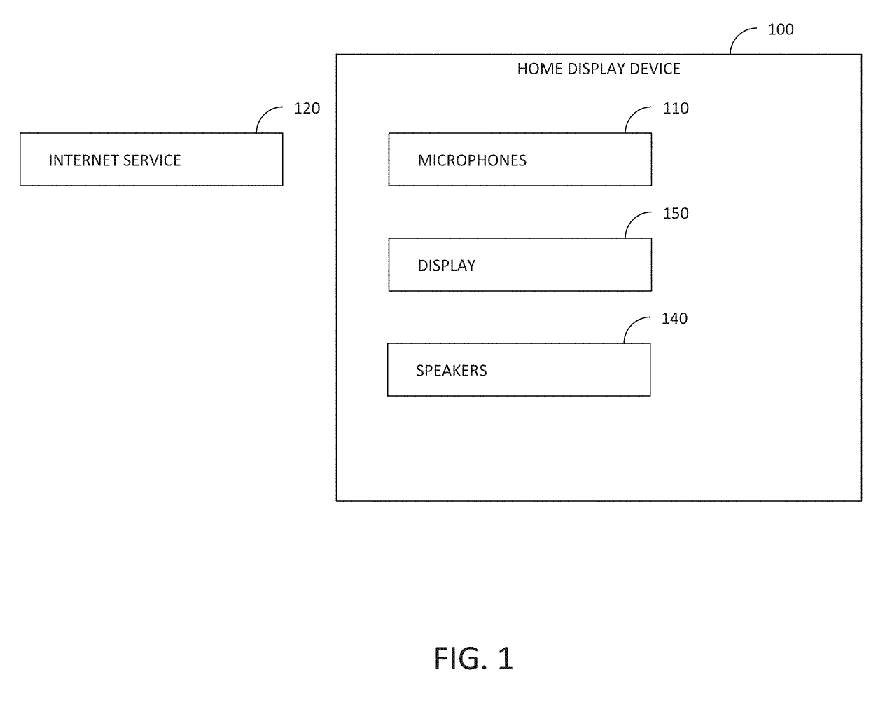

Referring to FIG. 1, a home display device 100 may be portable and suitable for being placed on a flat surface, such as a table or a desk. The home display device may be used within a home or used at any other suitable location. The home display device 100 may include one or more hands-free microphones 110 that are suitable to receive voice commands from one or more viewers. The home display device 100 may include a display 150 that includes one or more display segments that are suitable to receive input commands from one or more viewers. The home display device 100 may provide requests to an Internet based service 120, such as a cloud based service, that processes the voice commands and/or input commands from the home display device 100, and in response thereto, provides a suitable response and/or data to the home display device 100. The home display device 100 also preferably includes one or more speakers 140 and one or more display segments 150 so that responses can be provided to the one or more viewers in the form of audio content and/or audio-visual content and/or visual content and/or textual content and/or Internet-based content. For example, a viewer may request to the home display device 100 to play a particular type of video, provide a particular type of information, provide news, provide sports scores, provide a weather forecast, etc. In response to such a request, the home display device 100 may provide a request to the Internet based service 120, which in response thereto provides a response with responsive content to the home display device 100. The home display device 100 then provides the responsive information to the viewer, such as through the speakers 140 and/or the display segments 150. The home display device 100 may have a plurality of speakers, such as 2 or 3 or more speakers, arranged such that the audio content is directed in a plurality of directions around the device. Further, the home display device 100 may have a plurality of displays, such as 2 or 3 or more display segments, arranged such that the video content is readily observable in a plurality of directions from around the device. In general, all the separate display segments of the home display device 100 may be referred to as a portion of the display, with the collective of the segments being referred to as the display 150.

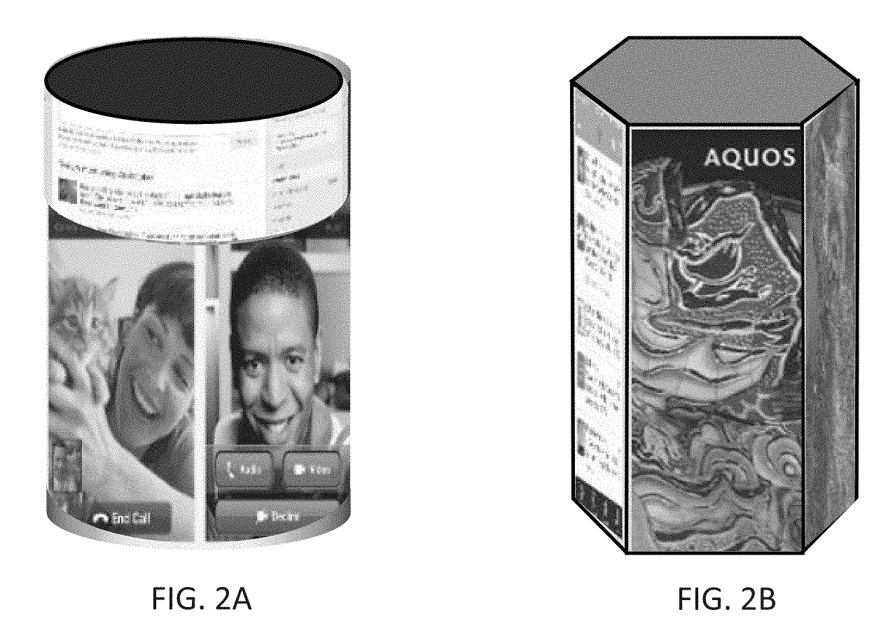

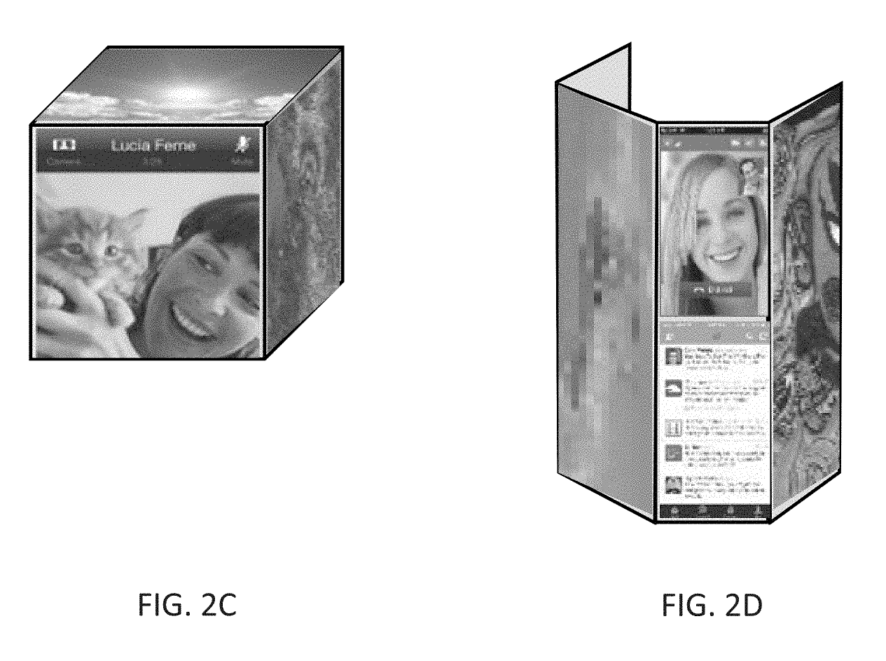

Referring to FIG. 2A, the home display device is preferably a cylindrical column with one or more speakers included therein and a convex display covering a majority of the circumference on the exterior surface thereof. Preferably, the convex display covers over 50 percent, and more preferably over 75 percent, of the circumference of the exterior thereof. Preferably, the convex display covers over 50 percent and more preferably over 75 percent, of the height of the exterior thereof. Moreover, preferably the display covers 50 percent and more preferably 75 percent or more of the exterior surface of the home display device. The device generally has a top-bottom vertical orientation and a bottom surface, on which the device may rest. As such the parts of the exterior surface covered by a display or display segments generally correspond to the sides and top parts of the device. The device and its display generally have a convex three-dimensional shape that allows viewing of content on the display from many viewing points surrounding the display, in particular from viewing points around the sides of the device and possibly from viewing points above the device. For suitable viewing, the three-dimensional shape is such that the viewing direction from many viewing points surrounding the display has a relatively small angle of inclination. That is, the angle between the direction of viewing and the normal vector in a sub-area of the surface of the display is relatively small, preferably smaller than 45 degree. Also, with such a generally continuous display around the home display device, the device may be substantially rotationally position independent for the rendering of content thereon. Other configurations if the device may likewise be used, such as, a pyramid shaped device or a cone shaped device. In other words, the shape of the device and display is such that there is a continuum of viewing points surrounding the display that allow viewing content being rendered on the display with a sufficient quality.

Referring to FIG. 2B, the home display device may include a multifaceted column. With a multifaceted column, each of the display segments may be flat with the collective of the segments being of a convex configuration. Preferably, the convex display covers over 50 percent, and more preferably over 75 percent, of the circumference of the exterior thereof. Preferably, the convex display covers over 50 percent and more preferably over 75 percent, of the height of the exterior thereof. Moreover, preferably the display covers 50 percent and more preferably 75 percent or more of the exterior surface of the home display device. Also, with such a generally continuous display around the home display device, the device may be substantially rotationally position independent for the rendering of content thereon.

Referring to FIG. 2C, the home display device may include a cube or rectangular prism. With a cube or rectangular prism, each of the display segments may be flat with the collective of the segments being of a convex configuration. Preferably, the convex display covers over 50 percent, more preferably over 75 percent, more preferably over 80 percent, and more preferably over 90 percent, of the circumference of the exterior thereof. Preferably, the convex display covers over 50 percent and more preferably over 75 percent, of the height of the exterior thereof. Moreover, preferably the display covers 50 percent and more preferably 75 percent or more of the exterior surface of the home display device. Also, with such a generally continuous display around the home display device, the device may be substantially rotationally position independent for the rendering of content thereon. Further, preferably the cube or rectangular prism includes a display on 4 surfaces (omitting 2 surfaces), more preferably a display on 5 surfaces (omitting 1 surface), and more preferably on 6 surfaces.

Referring to FIG. 2D, the home display device may include a plurality of segments that do not otherwise form a fully closed column or surface. With a multifaceted column, each of the display segments may be flat with the collective of the segments being of a convex configuration. Further, the segments may be connected together with a hinge so that each is movable with respect to the adjacent. Preferably, the convex display covers over 50 percent, more preferably over 75 percent, more preferably over 80 percent, and more preferably over 90 percent, of the circumference of the exterior thereof. Preferably, the convex display covers over 50 percent and more preferably over 75 percent, of the height of the exterior thereof. Moreover, preferably the display covers 50 percent and more preferably 75 percent or more of the exterior surface of the home display device. Also, with such a generally continuous display across the home display device, the device may be substantially rotationally position independent for the rendering of content thereon.

The display for the home display device may include a single unitary display or the display may comprise a plurality of display portions, such as a display on each facet of the home display device. The display may be included on all surfaces of the home display device, including the top and/or bottom, if desired. Each of the segments of the display may include its own display driver, if desired. Also, each of the segments of the display may share a single display driver, if desired. The home display device may include a processor, memory, network controllers, and associated electronics.

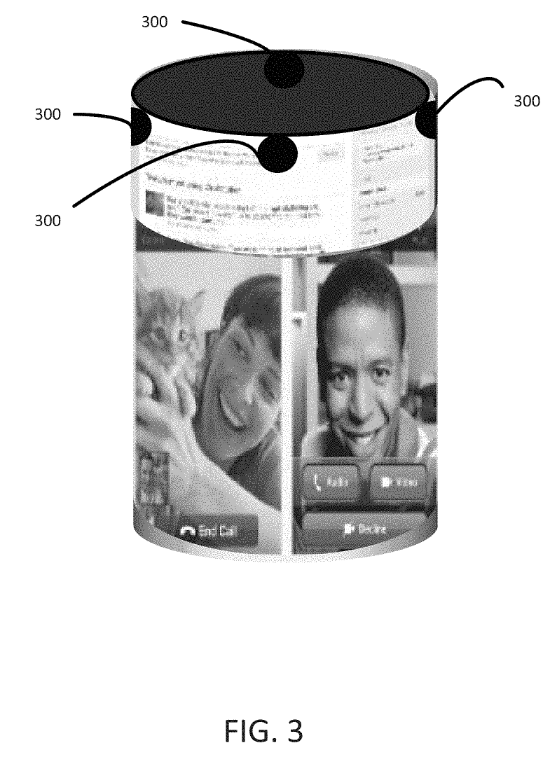

Referring to FIG. 3, based upon a plurality of microphones 300 of the home display device 100, the home display device 100 may receive the voice command from one or more viewers but may also determine the general location of each of the one or more viewers. For example, the home display device 100 may determine that a first viewer is toward a first direction. For example, the home display device 100 may determine that a second viewer is toward a second direction. For example, the home display device 100 may determine that a third viewer is toward a third direction (or the first direction or second direction). In this manner, the home display device 100 may discriminate the general direction of each viewer from the home display device 100. When a particular viewer requests information from the home display device 100, the responsive information may be provided to one or more speakers and/or one or more displays in the direction of the particular requesting viewer. For example, a first viewer from a first direction may request the sports scores while a second viewer from a second direction may request the news. In response, the home display device 100 may provide the sports scores audibly and/or visually in a portion of the display facing the general first direction, while at the same time the home display device 100 may provide the news audibly and/or visually in a portion of the display facing the general second direction. In this manner, multiple different viewers may be provided with responsive information at generally the same time in a direction that is consistent with their position relative to the home display device 100. The audible response may be provided with a plurality of speakers, each of which is directed in a generally different direction. The audible response may be provided with a single speaker, together with audible directional structures, such as movable baffles. The visual response may be provided with the segments of the display, each of which is directed in a generally different direction. The visual response may be provided with a single display, where different content is provided on different portions of the display consistent with the different directions.

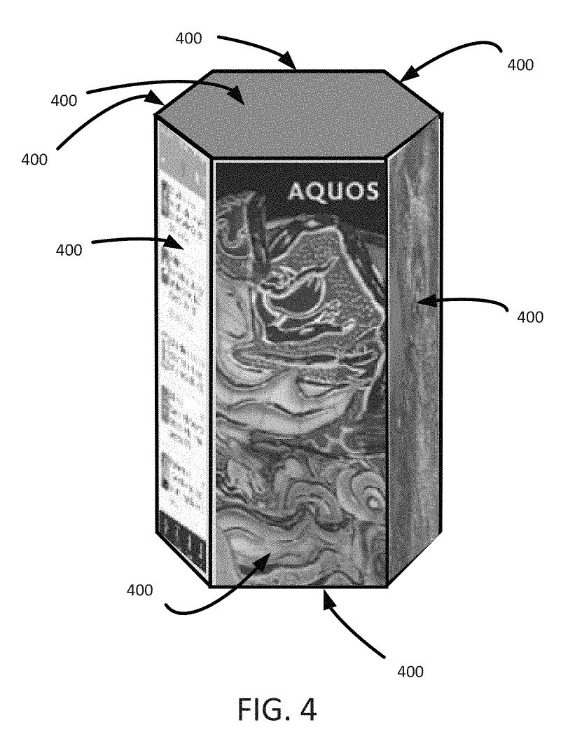

Referring to FIG. 4, based upon a display 400, or portions of one or more display segments, of the home display device 100, the home display device 100 may receive touch screen inputs (or a light pen, a mouse, or otherwise) to the display of commands from one or more viewers but may also determine the general location of each of the one or more viewers based upon the portion of the display thereof that received the input. For example, the home display device 100 may determine that a first viewer is toward a first direction. For example, the home display device 100 may determine that a second viewer is toward a second direction. For example, the home display device 100 may determine that a third viewer is toward a third direction (or the first direction or second direction). In this manner, the home display device 100 may discriminate the general direction of each viewer from the home display device 100. When a particular viewer requests information from the home display device 100, the responsive information may be provided to one or more speakers and/or one or more displays in the direction of the particular requesting viewer. For example, a first viewer from a first direction may request the sports scores while a second viewer from a second direction may request the news. In response, the home display device 100 may provide the sports scores audibly and/or visually in the general first direction, while at the same time the home display device 100 may provide the news audibly and/or visually in the general second direction. In this manner, multiple different viewers may be provided with responsive information at generally the same time in a direction that is consistent with their position relative to the home display device 100. The audible response may be provided with a plurality of speakers, each of which is directed in a generally different direction, to the general direction of the requesting viewer. The audible response may be provided with a single speaker, together with audible directional structures, such as movable baffles. The visual response may be provided with the segments of the display, each of which is directed in a generally different direction. The visual response may be provided with the display and portions thereof each of which, or portion thereof, is directed in a generally different direction.

As it may be observed, with a home display device including a display (or a plurality of display segments and/or portions) that are positioned around the home display device, a plurality of viewers may interact with the home display device in an different manner that is generally capable with a single flat display, such as a phone or tablet. Content may be rendered on sub-areas or portions of the display facing each viewer, in such a manner that each viewer can experience the content at the best possible viewing angle. Furthermore, with multiple viewers positioned around the home display device, each viewer may interact with the home display device and also be in a more convenient position to observe the other viewers and simultaneously interact with them. Moreover, with the non-flat display the rendering of content thereon suggests a stronger physical three dimensional like presence of other people, places, objects, and avatars that may be rendered on one or more portions of the display. For example, during a video conference call the multiple displays may provide a greater three dimensional appearance. Moreover, the content to be rendered on the display may be modified from its traditional two dimensional image to a modified two dimensional image that takes into account the curvature of one or more segments of the display, so that the content is rendered in a more three dimensional appearance to the viewer. Also, as one or more viewers move the audio and/or video content may be rendered to follow the respective viewer, for example by rendering the content in a limited display sub-area or display portion that is facing the respective viewer. In this manner, the viewing direction is close to the normal of the surface of the display near the center of the respective sub-area or portion of the display where the content is being rendered, and the viewer experiences the content at the best possible viewing angle.

As it may be observed, when only a single type of video content is being rendered, such as for a single viewer, then the content may be rendered on some or all of the segments of the display in a simultaneous manner. For example, when a viewer requests to watch a movie the movie may be rendered on each or a selected set of the segments of the display, in a selected sub-set of display sub-areas or portions. In a similar manner, when only a single type of audio content is being provided, such as for a single viewer, then the audio may be rendered on all of the speakers of the home display device in a simultaneous manner. For example, when a viewer requests to listen to a song the song may be provided on each or a selected set of the speakers of the home display device. The device may select a sub-set of display sub-areas, portions, or segments to render the visual content based on sensing the location, position, movement or viewing direction (gaze) of a viewer.

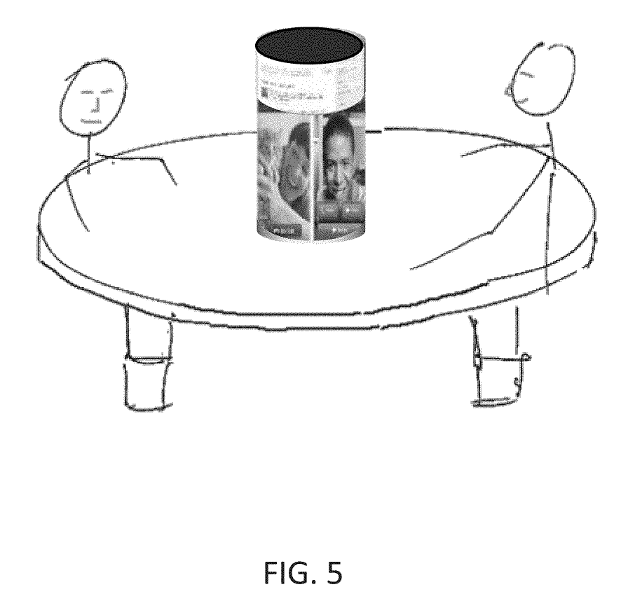

Referring to FIG. 5, a content sharing arrangement is illustrated where the home display device is placed on a table and a pair of viewers are sitting in an opposing arrangement from one another. Each of the viewers may observe a different (at least in part) portion of the display. Each of the viewers experiences the content rendered on the display with the best possible viewing angle. For example, a first viewer may observe a first portion of the display and the second viewer may observe the opposing portion of the display. In some cases, each of the viewers may observe the same content, or a portion of the same content, on their respective portion of the display. By way of example, the same content may be another content item that is displayed on both portions of the display, where this another content item is the same for both. For example, the first viewer may watch a football game and the another content item may be a stock ticker, while the second viewer may watch a soccer game and the another content item may be the same stock ticker rendered on a different portion of the display. Accordingly, a portion of the displayed content may be the same on two different portions of the display, and a portion of the displayed content may be customized for the particular viewer in such a manner that the two different portions of the display include unique content. The device may select a sub-set of display sub-areas, portions, or segments to render visual content based on sensing the location, position, movement or viewing direction (gaze) of one or more viewers.

For example, a first webpage may be rendered for the first viewer that includes in a first portion of the webpage with news together with the first viewer's personal schedule in a second portion of the webpage. In this manner, the first viewer has content that is both relatively generic to all people and content that is particularized for the first viewer. For example, a second webpage may be rendered for the second viewer that includes in the first portion of the webpage with news together with the second viewer's personal schedule in a second portion of the webpage. In this manner, the second viewer has content that is both relatively generic to all people and content that is particularized for the second viewer.

For example, each of the viewer may view different photos, such as on Instagram, and share such photos with one another through an interface on the device. For example, each of the viewers may view different videos, such as on Vine or YouTube, and share such videos with one another through an interface on the device. Furthermore, with the viewers being positioned across from each other as a result of the orientation of their respective portions of the display, the display device enables additional person-to-person interaction in addition to the content being displayed.

For example, each of the viewers may view different social media content and streaming content, such as a Facebook stream, a Twitter stream, Google+ content, LinkedIn content, and share such social media content and streaming content with one another through an interface on the device. Furthermore, with the viewers being positioned across from each other as a result of the orientation of their respective portions of the display, the display device enables direct eye contact and allows additional person-to-person interaction in addition to the content being displayed.

For example, each of the viewers may obtain different content from the same information assistant, such as touch commands or voice commands, to request content such as news, weather, stocks, etc., and share such informational content with one another through an interface on the device. Furthermore, with the viewers being positioned across from each other as a result of the orientation of their respective portions of the display, the display device encourages additional person-to-person interaction in addition to the content being displayed.

For example, each of the viewers may include different visual communications, such as touch commands or voice commands, to have a Skype call, Viber call, Google Hangouts, Video call, Chat, etc., and share such audio and/or visual interaction with one another through an interface on the device. Furthermore, with the viewers being positioned across from each other as a result of the orientation of their respective portions of the display, the display arrangement encourages additional person-to-person interaction in addition to the content being displayed.

For example, each of the viewers may include a different view of the same or different game, with interaction with touch commands or voice commands or other inputs, to engage with a multi-player game and/or multi-touch game, and share such informational content with one another through an interface on the device. Furthermore, with the viewers being positioned across from each other as a result of the orientation of their respective portions of the display, the display device encourages additional person-to-person interaction in addition to the content being displayed.

In another embodiment, each of the viewers may be observing the same scene of a virtual or real place, each of which is on a different segment of the display. While each of the viewers may be observing the same scene, each of the views may be different from one another, as it is rendered from a different viewpoint. In this manner, for example, two viewers may be observing an object such as a car. However, the first viewer may be observing the car from the front right of the car while the second viewer may be observing the car from the front left of the car, and according while the same place is being viewed each of the viewers will see the place from a different viewing angle. Furthermore, with the viewers being positioned across from each other as a result of the orientation of their respective portions of the display, the display device encourages additional person-to-person interaction in addition to the content being displayed.

In another embodiment, a single viewer may be observing the scene of a virtual or real place on the display segment in their direct view. If the viewer wishes to observe a different view of the place, the viewer may move to a different position around the home display device so that they may readily observe a different display segment, which has a different view of the scene. In this manner, the home display device may render multiple views of the same place, each of which with a different viewpoint that the viewer may observe. Furthermore, if the home display device is on a rotatable base, then the viewer may readily rotate the home display device so that each of the display segments may be viewed without the viewer having to move their location.

In another embodiment, the home display device may include environmental sensors such as temperature, humidity, noise, and lighting conditions. Further, the environmental sensors may be position dependent so that the environmental sensors is capable of discriminating the different environmental conditions in different directions, and modifying the rendering of audio and/or visual content for different display segments and/or audio based upon the respective environmental conditions. By way of example, there may be an ambient lighting sensor associated with each of the display segments and the display rendering may be modified based upon the associated ambient lighting sensor. By way of example, the volume from the speakers may be increased when there is substantial background noise.

In another embodiment, the home display device may include the capability of tracking the position and movement of the viewer or the gaze of the viewer, either through the microphones, touch display input, or other sensors, and the content rendered on the display may follow the viewer. For example, as the user moves from a first position to a second position, the content may likewise be initially rendered in a suitable manner for the first position and subsequently rendered in a suitable manner for the second position. For example, as the user changes their gaze from a first position to a second position, the content may likewise be initially rendered in a suitable manner for the first position and subsequently rendered in a suitable manner for the second position.

In another embodiment, the home display device may operate in cooperation with another home display device. Each of the home display devices may include the capability of tracking the movement of the viewer or the gaze of the viewer, either through the microphones, display input, or other sensors, and the content rendered on the respective display of the home display device may follow the viewer from one home display device to another home display device. For example, as the user moves from a first position to a second position, the content may likewise be initially rendered in a suitable manner for the first position on the home display device and subsequently rendered in a suitable manner for the second position on the another home display device. For example, as the user changes their gaze from a first position to a second position, the content may likewise be initially rendered in a suitable manner for the first position on the first home display device and subsequently rendered in a suitable manner for the second position for the another home display device.

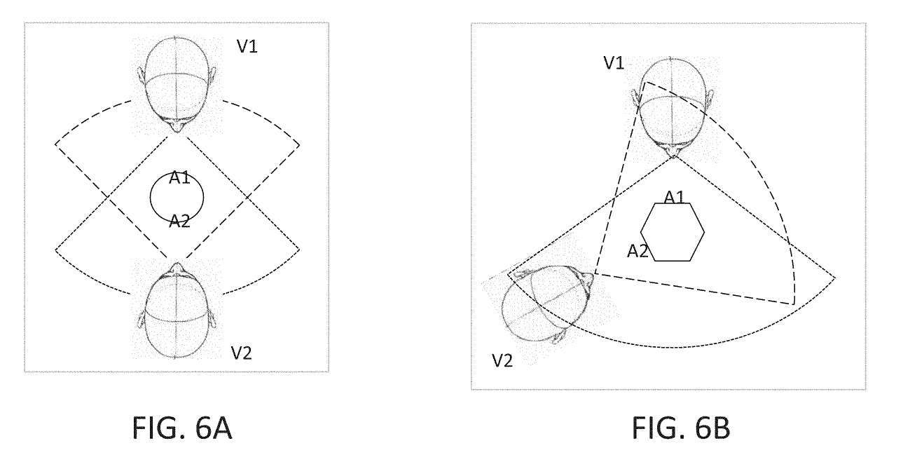

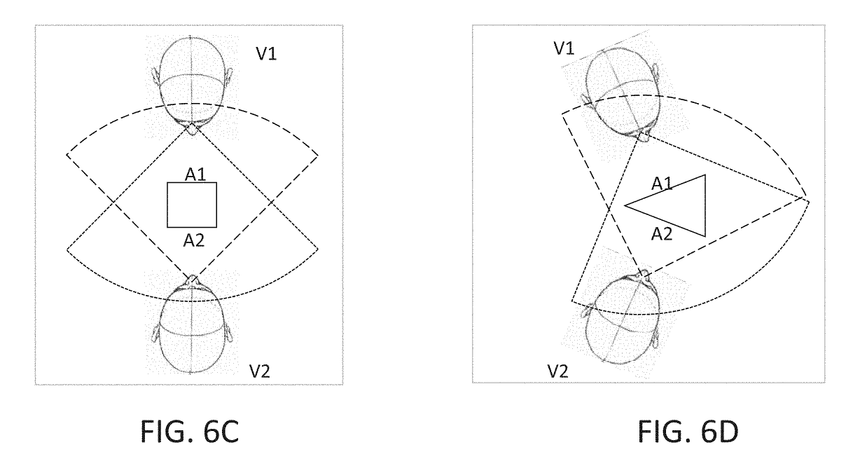

Referring to FIG. 6A, FIG. 6B, FIG. 6C, and FIG. 6D, illustrate a pair of viewers that simultaneously view and interact with a home display device on a single display while simultaneously being capable of observing each other. The first viewer observes the first display segment while the second viewer observes the second display segment, while each of the viewers are not in a position so that they may observe the other's display segment. It is also noted there is preferably a relatively small difference in the viewing angle of a viewer of the respective display segment and the other viewer.

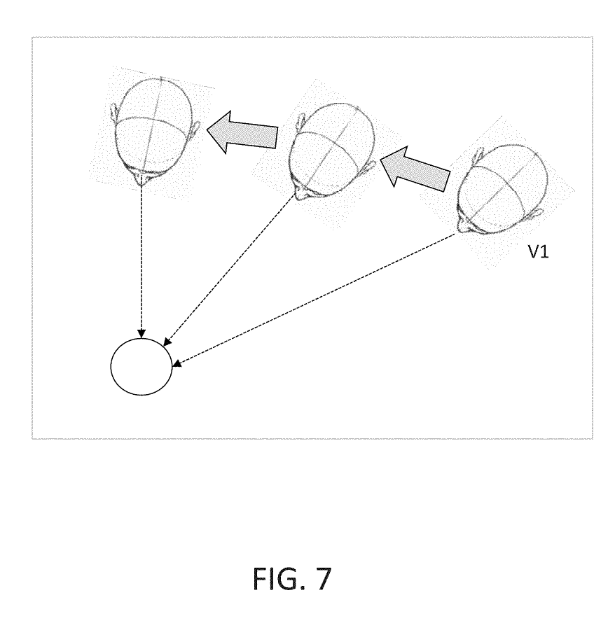

Referring to FIG. 7, a home display device is illustrated rendering content on multiple display segments forming a substantially continuous display surface. As the viewer moves to different locations the content may be rendered on different portions of the display depending on the viewer's position. In addition, the content may be rendered different in the different portion of the display.

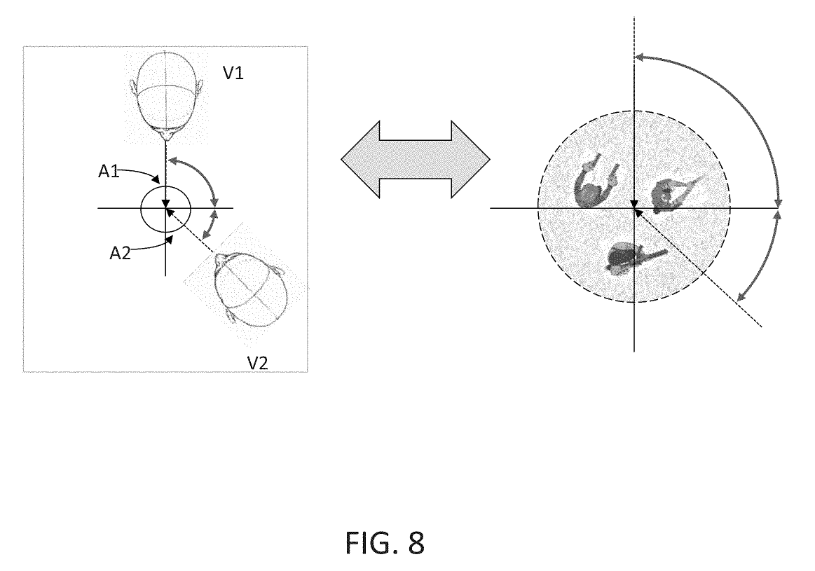

Referring to FIG. 8, a home display device is illustrated that renders a three dimensional content corresponding to a single three dimensional scene or object on multiple two dimensional portions of the display, as if the three dimensional scene is viewed from a corresponding viewing angle. By way of example, the three dimensional scene may be rendered on a display portion as if its “center” is aligned with the center of the home display device, and each rendering is created using a virtual camera at a position and a viewing angle relative to the scene that corresponds to the same position and viewing angle of each viewer relative to the corresponding display segment.

In another embodiment, each of the viewers typically has a mobile phone that includes a lock screen that displays content thereon. The lock screen may display messages from applications, such as text messages, iMessages, Facebook messages, and notifications. In some cases, the lock screen messages tend to be time sensitive and of particular importance. Until the viewer notices the messages, they may go unanswered or attended to. The mobile phone may be synchronized with the home display device, either directly through a wireless connection or through the Internet, such that when content is rendered on the lock screen the same (or similar) content may be automatically rendered on the home display device. In this manner, the lock screen content may be more readily observed.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

1. A display device with a substantially convex exterior surface comprising:
(a) a display covering at least a portion of said exterior surface;
(b) said display covering at least 50% of the circumference of said exterior surface;
(c) said display having a configuration such that said display is viewable from a plurality of viewing points surrounding said device, where from a first said viewing point a first portion of said display is viewable and from a second said viewing point a second portion of said display is viewable that is different than said first portion;
(d) said display including a plurality of display sub-areas capable of rendering visual content;
(e) said display device capable of selecting said first portion of said display to render a first content item for viewing on said first portion of said display viewable from said first said viewing point and simultaneously capable of selecting said second portion of said display to render a second content item for viewing on said second portion of said display viewable from said second said viewing point.

2. The display device of claim 1 further comprising a plurality of speakers.

3. The display device of claim 2 where said display device selects a first one of said speakers for audio based upon said location of a first viewer.

4. The display device of claim 3 wherein said display device selects a second one of said speakers for audio based upon said location of a second viewer.

5. The display device of claim 1 wherein said display of said display device covering over 75 percent of said circumference of said exterior surface.

6. The display device of claim 1 wherein said display of said display device covering over 50 percent of the height of said exterior surface.

7. The display device of claim 6 wherein said display of said display device covering over 75 percent of the height of said exterior surface.

8. The display device of claim 6 wherein said display of said display device covering over 50 percent of said exterior surface.

9. The display device of claim 1 wherein said exterior surface is substantially cylindrical.

10. The display device of claim 1 wherein said exterior surface is substantially a multifaceted column.

11. The display device of claim 1 wherein said exterior surface is substantially a rectangular prism.

12. The display device of claim 1 wherein said exterior surface is a plurality of hinged segments.

13. The display device of claim 1 wherein,
(a) said first content item is rendered together with another content item on said first portion;
(b) said second content item is rendered together with said another content item on said second portion;
(c) where each of said first content item, said second content item, and said another content item are different from one another.

14. The display device of claim 13 wherein said first content item is particularized to a first viewer and said second content item is particularized to a second viewer.

15. The display device of claim 1 further comprising a second display device where said second display device operates in cooperation with said display device.

16. The display device of claim 1 where said selecting said first portion of said display is based upon a direction of a first viewer.

17. The display device of claim 1 where said selecting said first portion of said display is based upon a location of a first viewer.

18. The display device of claim 1 where said selecting said first portion of said display is based upon a direction of a first viewer and said selecting said second portion of said display is based upon a direction of a second viewer.

19. The display device of claim 1 where said selecting said first portion of said display is based upon a location of a first viewer and said selecting said second portion of said display is based upon a location of a second viewer.

20. The display device of claim 1 where said selecting said first portion of said display is based upon a direction of a first viewer based upon a camera.

21. The display device of claim 1 where said selecting said first portion of said display is based upon a location of a first viewer based upon a camera.

22. The display device of claim 1 where said selecting said first portion of said display is based upon a direction of a first viewer based upon a camera and said selecting said second portion of said display is based upon a direction of a second viewer based upon said camera.

23. The display device of claim 1 where said selecting said first portion of said display is based upon a location of a first viewer based upon said camera and said selecting said second portion of said display is based upon a location of a second viewer based upon said camera.

24. The display device of claim 1 where said selecting said first portion of said display is based upon a direction of a first viewer based upon a microphone.

25. The display device of claim 1 where said selecting said first portion of said display is based upon a location of a first viewer based upon a microphone.

26. The display device of claim 1 where said selecting said first portion of said display is based upon a direction of a first viewer based upon a microphone and said selecting said second portion of said display is based upon a direction of a second viewer based upon said microphone.

27. The display device of claim 1 where said selecting said first portion of said display is based upon a location of a first viewer based upon a microphone and said selecting said second portion of said display is based upon a location of a second viewer based upon said microphone.
